(19) United States
(12) Patent Application Publication
(10) Pub. No.: US 2008/0001690 A1
(43) Pub. Date: Jan. 3, 2008

(54) Micro scanner and manufacturing process, driving structure and driving method therefor

(75) Inventors: Huseh-An Yang, Hsinchu (TW); Weileun Fang, Hsinchu (TW); Tsung-Lin Tang, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: National Tsing Hua University, Hsinchu (TW)

(21) Appl. No.: 11/650,402

(22) Filed: Jan. 5, 2007

(30) Foreign Application Priority Data
Jul. 3, 2006 (TW) 095124215

(51) Int. Cl. H01H 1/00

(52) U.S. Cl. 335/213

(57) ABSTRACT

A method for manufacturing a magnetic-induction element is provided. The method includes steps of: a) providing a substrate, b) forming an adhesive layer on the substrate, c) forming a seed layer on the adhesive layer, d) removing a part of the seed layer to reveal a part of the adhesive layer, e) partially forming a resistance on the seed layer and the revealed part of the adhesive layer, f) forming a magnetic-induction layer on the seed layer and the revealed part of the adhesive layer, g) removing the resistance, and h) removing a part of the substrate and the revealed part of the adhesive layer.

### FIELD OF THE INVENTION

The present invention relates to a magnetic-induction element and its manufacture, driving structure, and driving method. In particular, it is relevant to the magnetic-induction element driven by Lorentz force and its manufacture, driving structure, and driving method.

### BACKGROUND OF THE INVENTION

Micro scanning mirror manufactured using silicon as a substrate was first published in 1980. Since then, the micro scanning mirror has become an area of important research in the study of optical Micro Electro Mechanical Systems. The main applications of the micro scanning mirror include appliances such as, scanners, bar code machines, laser printers and projectors. In the application in projection display system, micro scanning mirrors are further categorized into three types: 1. two-dimensional matrix; 2. one-dimensional scanning system; and 3. raster-scanned system.

The most well-known example for two-dimensional matrix is the Digital Micromirror Device (DMD), also known as Digital Light Processor (DLP) technique, manufactured by Texas Instruments.

One example of one-dimensional scanning system is the Grating Light Valve (GLV) that adopts principles of light reflection.

The raster-scanned system responds to the light source. It either scans vertically and horizontally by using two separate mirrors or uses one mirror for both dimensions. This system is usually applied to virtual projection displays and laser projection displays.

The earlier Cathode Ray Tube Televisions belong to the category of raster-scanned scanning system. In a vacuum environment, the direction of deflection of electronic beams is controlled by magnetic fields. The electronic beams are projected towards the phosphorescent screen, the phosphorescent powders on which then become excited and emit light. Since the introduction of Micro Electro Mechanical Systems (MEMS), scanning mirrors based on light projection have been in continuous development. Their manufacture employs bulk micromachining technique and surface micromachining technique.

There are various approaches to drive micro scanning mirrors, and the most commons are the static actuation and the heat actuation. Due to the limitation of size effect, there are fewer examples of micro mirrors driven by magnetic actuation.

In principle, when the electric current is perpendicular to the magnetic field, Lorentz force will be generated. Such force could be utilized to control the micro scanning mirror.

Please refer to FIG. 1, which is a preferred embodiment of the structure of a conventional micromirror. As illustrated in FIG. 1, the micromirror 1, manufactured with silicon as substrate, was etched and lined with the electroplated copper conducting wire 3 by micro electroform. Two magnets (not shown) are then installed to provide a permanent magnetic field. When the current flows from torsion bar 2 to micromirror 1, it interacts with the magnetic field and Lorentz force is generated therefrom. Since the direction of current will change after passing through torsoin bar 2, the direction of resulting Lorentz force will also change, inducing torque at the micromirror 1. If the input signal is alternating current, the micromirror 1 will resonate in high motion. Since the driving source is electric current, wires must be thickened by electroplating in order to reduce its resistance and hence the Joule heat generated along the conducting wire. Furthermore, as wires could only be further processed by the flat machining, it is impossible to produce wires in the form of three-dimensional coils. Thus, wires are intertwined and usually routed by 3D crossing, for example, by connecting through jumper 4.

However, conventional micro mirrors driven by Lorentz force have two drawbacks. Firstly, wiring requires coils, the production of which incurs expense. Secondly, it is vital to avoid production of Joule heat when large electric currents pass through coils. To complicate matters, these two difficulties are not mutually exclusive. Although electroplating thickens wires and thus provides solution for problem of Joule heat, it increases wiring cost. If the thickness of wire is inadequate, too strong a current generating Joule heat will be able to melt wires. In addition, the structure of conducting wires is to be fully built during the process of electroplating, in order to eliminate any possibility of melting. This further raises production cost.

In light of these drawbacks of the existing apparatus, a magnetic induction micromirror driven by electromagnetism, its manufacturing procedures, driving structure and driving method are provided. The magnetic induction element (composed of ferromagnetic materials) is driven by the interaction between external magnetic field and electric current generated during electromagnetic induction.

### SUMMARY OF THE INVENTION

In accordance with an aspect of the present invention, a method for manufacturing a magnetic-induction element is provided. The method includes steps of: a) providing a substrate, b) forming an adhesive layer on the substrate, c) forming a seed layer on the adhesive layer, d) removing a part of the seed layer to reveal a part of the adhesive layer, e) partially forming a resistance on the seed layer and the revealed part of the adhesive layer, f) forming a magnetic-induction layer on the seed layer and the revealed part of the adhesive layer, g) removing the resistance, and h) removing a part of the substrate and the revealed part of the adhesive layer.

Preferably, either of the steps b) and c) is performed by a deposition.

Preferably, each of the steps d), g) and h) is performed by an etching.

Preferably, the step f) is performed by an electroplating.

In accordance with another aspect of the present application, a method for manufacturing a magnetic-induction element is provided. The method includes steps of a) providing a substrate having a seed layer and an adhesive layer thereon, b) removing a part of the seed layer to reveal a first part of the adhesive layer, c) forming a first magnetic-induction layer on the first part of the adhesive layer and a second magnetic-induction layer on the seed layer, and e) removing the first part of the adhesive layer and a part of the substrate under the first part of the adhesive layer.

Preferably, either of the steps b) and d) is performed by an etching.

In accordance with a further aspect of the present application, a magnetic-induction element is provided. The magnetic-induction element includes a substrate, an adhesive layer mounted on the substrate, a seed layer mounted on the adhesive layer, and a magnetic-induction layer mounted on the seed layer and having an actuating portion and a first axis connected to the actuating portion.

Preferably, the magnetic-induction layer is a metal layer being one of a nickel layer and a nickel alloy layer.

Preferably, the substrate is a silicon substrate, the adhesive layer is a titanium layer and the seed layer is a copper layer.

Preferably, the magnetic-induction element further includes a frame connected with the first axis.

Preferably, the magnetic-induction layer further includes a second axis and a ring portion connected with the actuating portion via the first axis.

Preferably, the magnetic-induction element further includes a frame connected with the ring portion through the second axis.

In accordance with a further aspect of the present application, a magnetic-induction element is provided. The magnetic-induction element includes a substrate having a connecting structure, and a magnetic-induction layer connected to the connecting structure and having an actuating portion and a first axis connected to the actuating portion.

Preferably, the connecting structure has a first metal layer and a second metal layer.

Preferably, the magnetic-induction layer is a third metal layer.

Preferably, the third metal layer is one of a nickel layer and a nickel alloy layer.

In accordance with a further aspect of the present application, a driving structure is provided. The driving structure includes a frame having a first portion, a second portion and a third portion supporting a magnetic-induction element, a first magnetic device mounted on the first portion, a second magnetic device mounted on the second portion, a generating device providing a variable magnetic field to the magnetic-induction element, a mixer electrically connected to the generating device, and a current source electrically connected to the mixer.

Preferably, the first and second magnetic devices are permanent magnets having different magnetic poles.

Preferably, the generating device causes an induction current generated on the magnetic-induction element.

Preferably, the current source includes a first current generating device and a second current generating device.

In accordance with a further aspect of the present application, a driving structure is provided. The driving structure includes a frame supporting a magnetic-induction element, a first magnetic device and a second magnetic device, a generating device providing a variable magnetic field to the magnetic-induction element, and a current source electrically connected to the generating device.

Preferably, the first and second magnetic devices are permanent magnets having different magnetic poles.

Preferably, the generating device causes an induction current generated on the magnetic-induction element.

Preferably, the current source includes a mixer, a first current generating device and a second current generating device.

In accordance with a further aspect of the present application, a method for driving a magnetic-induction element is provided. The method includes steps of a) assembling a driving structure having a first magnetic device, a second magnetic device, and a supporting portion having the magnetic-induction element thereon, wherein a permanent magnetic field is provided between the first magnetic device and the second magnetic device, b) providing a magnetic field to the magnetic-induction element, and c) varying the magnetic field to form an induction current on the magnetic-induction element, whereby the magnetic-induction element is driven by a Lorentz force generated between the induction current and the permanent magnetic field.

Preferably, the step c) is performed by controlling a current generating the magnetic field.

Preferably, the current is provided from a mixer.

Preferably, the current is provided from a mixer and a current generating device.

Preferably, the magnetic-induction element is one of a single-axis element and a dual-axis element.

In accordance with a further aspect of the present application, a method for driving a magnetic-induction element is provided. The method includes steps of a) applying a first magnetic field to the magnetic-induction element, b) providing a second magnetic field to be applied to the magnetic-induction element, and c) varying the second magnetic field to form an induction current on the magnetic-induction element. The magnetic-induction element is driven by a Lorentz force generated between the induction current and the first magnetic field.

Preferably, the step c) is performed by controlling a current generating the magnetic field.

Preferably, the current is provided from a mixer and/or a current generating device.

Preferably, the magnetic-induction element is one of a single-axis element and a dual-axis element.

Preferably, the first magnetic field is a permanent magnetic field.

In a further aspect of the present application, a projection system is provided. The projection system includes a driving structure having a first magnetic device, a second magnetic device and a generating device providing a magnetic field, and a magnetic-induction element mounted between the first magnetic device and the second magnetic device and within the magnetic field.

Preferably, the first and second magnetic devices are permanent magnets having different magnetic poles.

Preferably, the magnetic-induction element is mounted within a permanent magnetic field formed by the first and second magnetic devices.

Preferably, the generating device causes an induction current generated on the magnetic-induction element.

Preferably, the magnetic-induction element is driven by a Lorentz force generated between the induction current and the permanent magnetic field.

Preferably, the projection system further includes a mixer.

Preferably, the projection system further includes a current source.

Preferably, the magnetic-induction element is one of a single-axis element and a dual-axis element.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram of the structure of a prior micromirror;

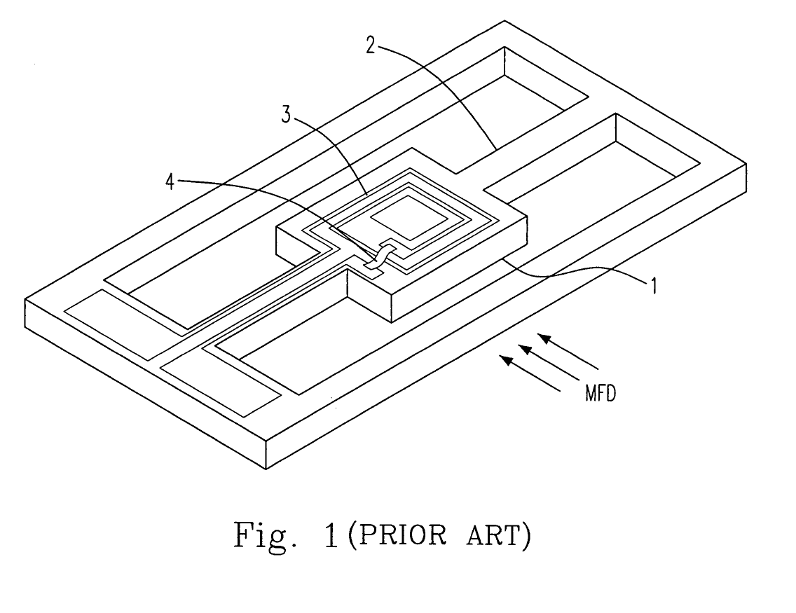

FIG. 2 is a diagram showing a one-axis scanning mirror according to a preferred embodiment of the present application;

FIG. 3 is a diagram showing a two-axis scanning mirror according to a preferred embodiment of the present application;

FIGS. 4(A)-(G) show a flow chart of a manufacturing method for a two-axis twist micromirro according to a preferred embodiment of the present application;

FIG. 5 is a diagram of a driving structure according to a preferred embodiment of the present application;

FIG. 6 is a diagram of the projection system according to a preferred embodiment of the present application;

FIG. 7 is a diagram showing the driving method for the micro mirror according to a preferred embodiment of the present application;

FIG. 8 is a diagram showing the driving method for the micro mirror according to a preferred embodiment of the present application; and

FIG. 9 is a diagram showing temperature change of micromirror applied with different alternating magnetic field frequencies according to a preferred embodiment of the present application.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

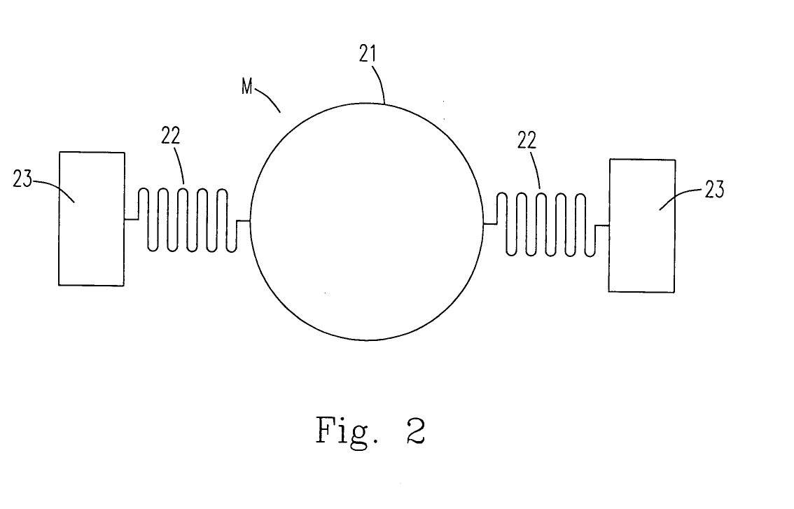

Please refer to FIG. 2, which is a diagram showing a one-axis scanning mirror according to a preferred embodiment of this application. The one-axis scanning mirror has the actuator 21, the first rotating axis 22 and the outer frame 23.

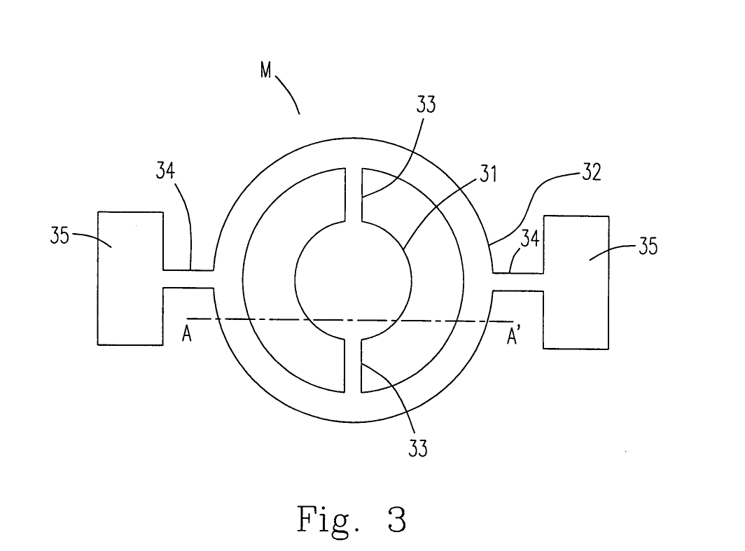

Please refer to FIG. 3, which shows a two-axis scanning micro scanning mirror according to a preferred embodiment of the present application. As shown in FIG. 3, the two-axis micro scanning mirror includes the actuator 31, the circular portion 32, the first rotating axis 33, the second rotating axis 34 and the outer frame 35. Although the first rotating axis 33 is perpendicular to second rotating axis 34 in this embodiment, the angle in between could be altered to create different effects during actual operation. For example, the angle could be 89°, 88°, 85°, 80° or any other degrees. It is to be noted that the design appearance and size of the first rotating axis 33 and the second rotating axis 34 could be adjusted according to need.

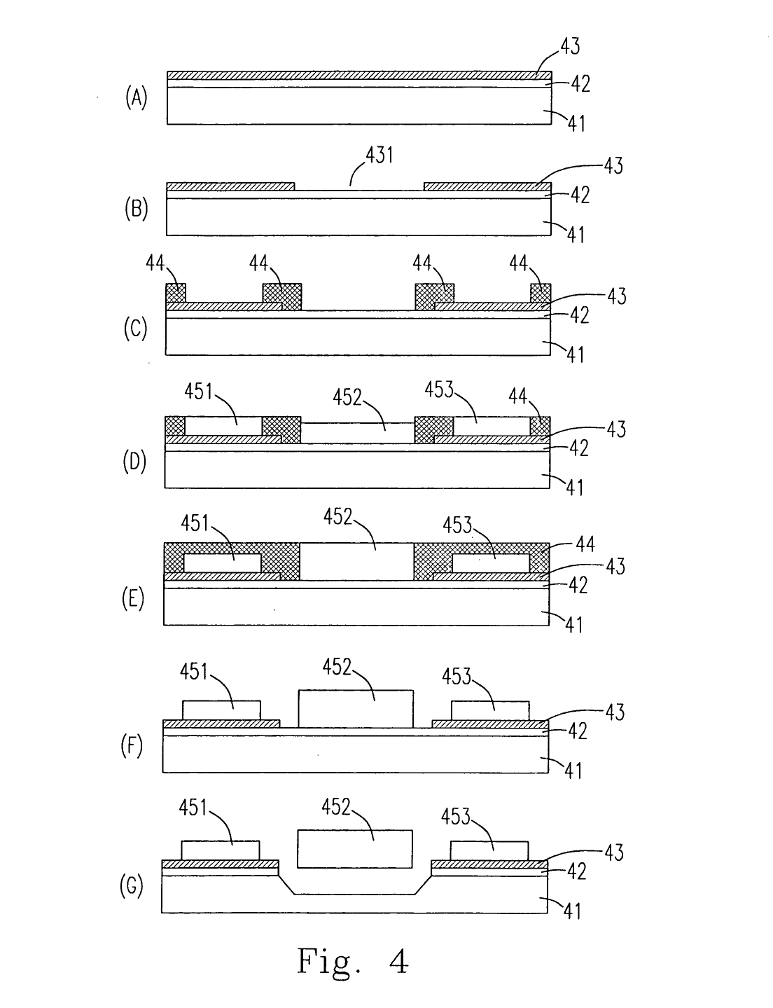

Please refer to FIG. 4(A)-(G), which demonstrates the steps of manufacturing the two-axis micro scanning mirror. During operation, the manufacture starts with depositing a titanium layer 42 (used as adhesive layer) on top of a wafer 41 (silicon wafer in this embodiment) by electronic steam-plating, before the deposition of a copper layer 43 (as seeding layer). It is to be noted that the titanium layer 42 and the copper layer 43 could be considered as a connecting structure. FIG. 4 (A) shows the initial tri-layer. Copper layer 43 was further etched to form an opening 431 and the revealed titanium layer 421 are then exposed, as shown in FIG. 4 (B). The resistance 44 (AZ4620 was used in this embodiment) is then formed on the titanium layer 42 and the copper layer 43 and then patterned (FIG. 4(C)). Magnetic induction layers 451, 452 and 453 (as in FIG. 4(D)) were subsequently formed (the magnetic induction layers 451, 452 land 453 ared formed by electroplating the nickel metal in this embodiment). FIG. 4(E) shows the thickened magnetic induction layer 452 and the resistance 44. The thickened magnetic induction layer 452 relative to the magnetic induction layers 451 and 453 provides greater rigidity and allows more magnetic induced eddy current to be generated. The resistance 44 was then removed before the exposed titanium layer 42, which is not protected by copper layer 43 (the removal of the titanium layer 42 is via BOE in this embodiment). FIG. 4(F) shows the result after removal of these layers. Lastly, wafer 41 is etched by TMAH to form the two-axis micro scanning mirror M, as shown in FIG. 4(G). It is to be noted that FIG. 4(G) can be viewed as the structural cross section along A-A′ line in FIG. 3. The actuator 31 in FIG. 3 is equivalent to the magnetic induction layer 452 in FIG. 4(G), whilst the circular portion 32 in FIG. 3 includes the magnetic induction layers 451 and 453 in FIG. 4(G). Although the titanium layer 42, copper layer 43 and nickel layers are an adhesive layer, a seeding layer and the magnetic induction layers 451, 452 and 453 respectively in this embodiment, the materials used could be substituted according to need during actual operation. In another word, other materials appropriate for use as adhesive layers, seeding layers or magnetic induction layers are suitable for this application. For example, metals such as nickel copper alloy or nickel iron alloy could replace nickel layers to form the magnetic induction layer. Moreover, this embodiment refers to the manufacture of two-axis micro scanning mirror, and it therefore requires separation of magnetic induction layer 452 and wafer 41. However, a one-axis micro scanning mirror, when required in an operational event, can be simply manufactured by the sequential formation of adhesive layer and seeding layer and magnetic induction layer.

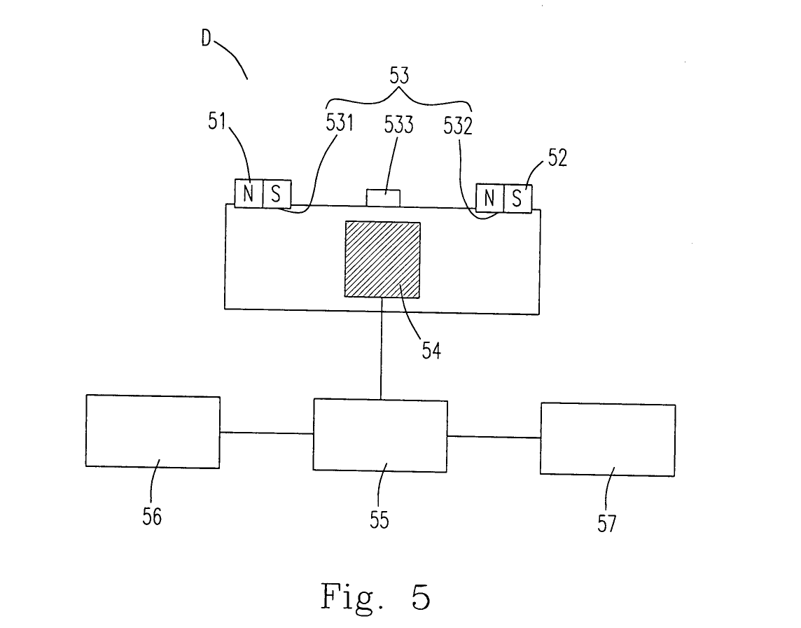

Please refer to FIG. 5, which is a preferred embodiment of the driving structure in this application. As illustrated in FIG. 5, the driving structure D in this application includes the first magnetic device 51, the second magnetic device 52, the frame 53, the magnetic field generating device 54 (such as solenoid), the mixer 55, the first current generating device 56 and the second current generating device 57. It is to be noted that the first current generating device 56 and the second current generating device 57 (and the mixer 55) could be considered as a current source device. Among these, the magnetic field generating device 54 is applied to a magnetic induction element (not shown) to provide a variable magnetic field. Thus, its installation position is adjustable, providing that it is able to modify the magnetic field of the magnetic induction element. Furthermore, although both the first magnetic device 51 and the second magnetic device 52 in this embodiment use permanent magnets, other designs are appropriate during actual operation, as long as the magnetic force persists. In addition, the frame 53 includes the first supporting portion 531, the second supporting portion 532 and the third supporting portion 533 that carry the first magnetic device 51, the second magnetic device 52 and the magnetic-induction element (not shown) respectively. Although this embodiment encompasses two current generating devices 56 and 57 and one mixer 55, one current source controller is adequate for controlling the change of magnetic field during actual operation.

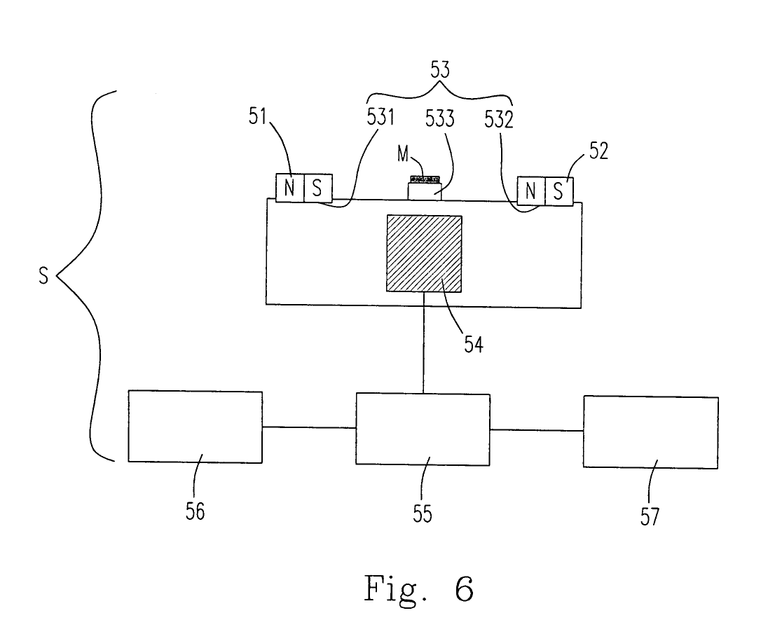

Please refer to FIG. 6, which is a preferred embodiment of the projection system proposed in this application. As illustrated in FIG. 6, the projection system S in this embodiment includes the micro scanning mirror M, and the first magnetic device 51, the second magnet device 52, the frame 53, magnetic field generating device 54 (such as solenoid), the mixer 55, the first current generating device 56, and the second current generating device 57 in FIG. 5. Amongst these, the frame 53 includes the first supporting portion 531, the second supporting portion 532 and the third supporting portion 533 that carry the first magnetic device 51, the second magnetic device 52 and the micro scanning mirror M respectively.

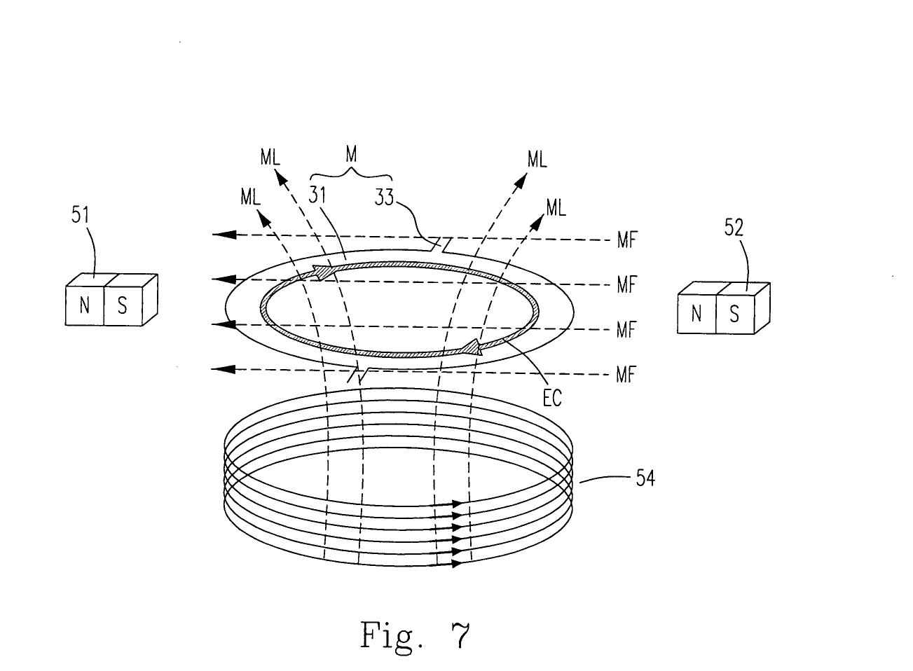

Please refer to FIG. 3, FIG. 6 and FIG. 7. FIG. 7 shows a diagram of the driving method for the micro sensing mirror according to the preferred embodiment of the present application. For the convenience of illustration, only the actuator 31 (equivalent to magnetic induction layer 452 of FIG. 4), the first rotating axis 33, the first magnetic device 51, the second magnetic device 52 and the magnetic field generating device 54 in two-axis micro scanning mirror M were drawn in FIG. 7. As shown in FIG. 7, the eddy current (EC) is induced in the actuator 31 in response to the varying magnetic lines (ML) created by the magnetic field generating device 54. The presence of eddy current and the magnetic force between the first magnetic device 51 and the second magnetic device 52 lead to the generation of Lorentz Force so as to rotate the actuator 31 around the first rotating axis 33.

As described above, this invention achieves the objective of driving an element purely with a force acting at a distance. In addition, since the eddy current is a surface current that distributes to every corner of the micro scanning mirror, Lorentz Force is generated everywhere on the micro scanning mirror. As the intensity of the electromotive force is directly proportional to the induction area, the further it is from the center of the mirror the more intense the potential energy and the greater the consequently generated eddy current and Lorentz Force. From mechanics point of view, the further it is from the center, the greater the torque. From manufacturing point of view, complicated coil routing is prevented as the eddy current is generated by induction. Since the close loop surface eddy current runs across the micro scanning mirror automatically, only the machine's structure is required to be manufactured, whilst the induction generates both the electric and magnetic signals. Thus, this invention effectively circumvents the huge expenditure incurred from learning the complicated coil routing.

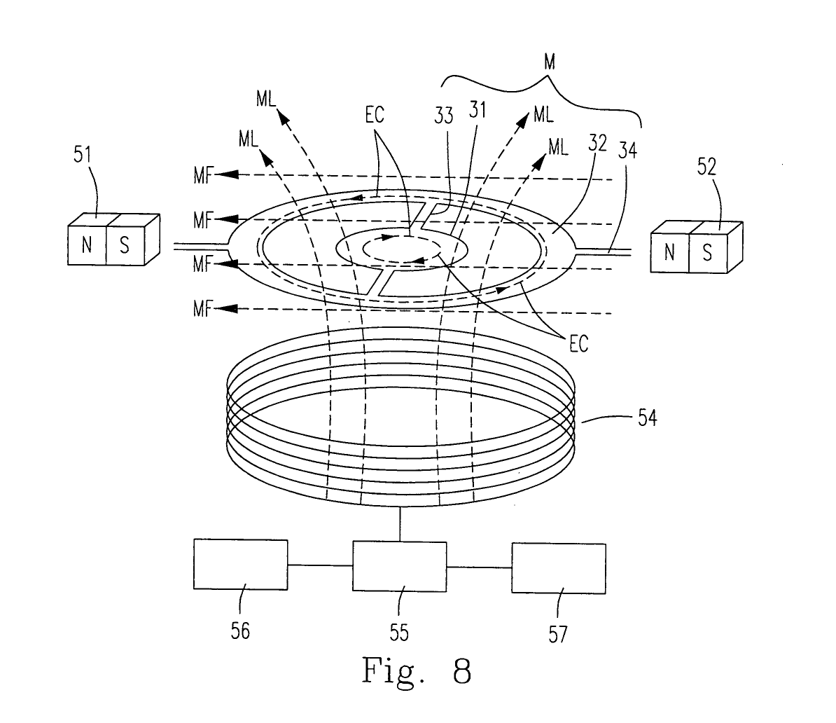

Please refer to FIG. 3, FIG. 6 and FIG. 8. FIG. 8 shows a driving method for micro scanning mirror according to a preferred embodiment of this application. For the convenience of illustration, only the actuator 31, the circular portion 32, the first rotating axis 33, the second rotating axis 34, the first magnetic device 51, the second magnetic device 52, the magnetic field generating device 54, the mixer 55, the first current generating device 56 and the second current generating device 57 in the two-axis micro scanning mirror M are drawn in FIG. 8. Since the first rotating axis 33 and the second rotating axis 34 of the two-axis micro scanning mirror M could be of different rigidity (i.e. the first and second rotating axes manufactured could be of varying thickness and shape), and the driving source for the both axes is from the same magnetic field generating device 54, if the two types of signals (from the first current generating device 56 and the second current generating device 57 respectively) are simultaneously entered, the both axes 33 and 34 are actuated simultaneously. Trials revealed that if the direction of magnetic force generated between the first magnetic device 51 and the second magnetic device 52 is not perpendicular to that of first rotating axis 33, the actuactor 31 and the circular portion 32 of the two-axis micro scanning mirror M could create torsions simultaneously in different orientations. For example, in this embodiment, one could scan horizontally whilst the other could scan vertically. Trials further demonstrate that controlling the frequencies of the first current generating device 56 and the second current generating device 57 could control the condition of different scanning (such as the horizontal scanning and vertical scanning in this embodiment)of micro scanning mirror M.

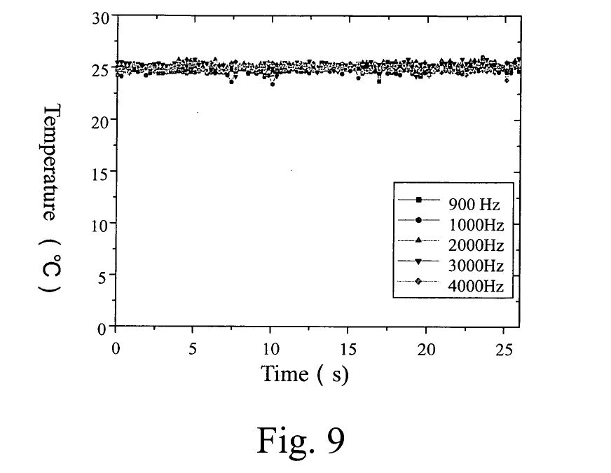

In the prior micro scanning mirror that employs Lorentz Force as a driving force, Joule heat is produced as a result of direct flowing of electric current. The production of heat deforms its structure and even affects its motion behavior. As the electric current of this application is not directly forced upon the mirror face and is created by induction instead, the power of alternating magnetic field becomes relatively small and the Joule heat created is minimized. As illustrated in FIG. 9, the temperature measured with increasing frequency of alternating magnetic field (900 Hz, 1000 Hz, 2000 Hz, 3000 Hz and 4000 Hz) did not increase substantially over a period of 25 seconds. Therefore, the induced current employed to drive the micro scanning mirror in this embodiment effectively diminishes the Joule heat produced.

In summary of the aforesaid discussions, the present application provides a new form of micro sensing mirror driven by Florentz Force. It is a non-coil scanning mirror that circumvents the needs of wiring coils on the mirror surface. Since the appliance is assembled in accordance with the outer magnetic field and magnetic force generating devices, a method of driving the single or two-axis scanning mirrors by a single driving source is achieved. In addition, the flexibility of the relative positions of the electric field and the electric force generating devices and the scanning mirror diversifies the application of this invention. Since the magnetic induction element, its manufacture, driving structure and driving methods have not been mentioned in prior art, these innovations have advantages, such as its ease of manufacture, elements with high sensitivity, flexibility of the structure of elements, low power consumption and simple driving methods. Thus, this embodiment possesses originality, non-obviousness and huge industrial applicability. Last but not least, although the micro scanning mirror is illustrated in the preferred embodiment, the manufacture, driving structure and method of this application are not restricted to MEMS element and are of potential to be further applied to other fields.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for manufacturing a magnetic-induction element, comprising steps of:
a) providing a substrate;
b) forming an adhesive layer on the substrate;
c) forming a seed layer on the adhesive layer;
d) removing a part of the seed layer to reveal a part of the adhesive layer;
e) partially forming a resistance on the seed layer and the revealed part of the adhesive layer;
f) forming a magnetic-induction layer on the seed layer and the revealed part of the adhesive layer;
g) removing the resistance; and
h) removing a part of the substrate and the revealed part of the adhesive layer.

2. A method as claimed in claim 1, wherein either of the steps b) and c) is performed by a deposition.

3. A method as claimed in claim 1, wherein each of the steps d), g) and h) is performed by an etching.

4. A method as claimed in claim 1, wherein the step f) is performed by an electroplating.

5. A method for manufacturing a magnetic-induction element, comprising steps of:
a) providing a substrate having a seed layer and an adhesive layer thereon;
b) removing a part of the seed layer to reveal a first part of the adhesive layer;
c) forming a first magnetic-induction layer on the first part of the adhesive layer and a second magnetic-induction layer on the seed layer; and
d) removing the first part of the adhesive layer and a part of the substrate under the first part of the adhesive layer.

6. A method as claimed in claim 5, wherein either of the steps b) and d) is performed by an etching.

7. A magnetic-induction element, comprising;
a substrate;
an adhesive layer mounted on the substrate;
a seed layer mounted on the adhesive layer; and
a magnetic-induction layer mounted on the seed layer and comprising an actuating portion and a first axis connected to the actuating portion.

8. A magnetic-induction element as claimed in claim 7, wherein the magnetic-induction layer is a metal layer being one of a nickel layer and a nickel alloy layer.

9. A magnetic-induction element as claimed in claim 7, wherein the substrate is a silicon substrate, the adhesive layer is a titanium layer and the seed layer is a copper layer.

10. A magnetic-induction element as claimed in claim 7 further comprising a frame connected with the first axis.

11. A magnetic-induction element as claimed in claim 7, wherein the magnetic-induction layer further comprises a second axis and a ring portion connected with the actuating portion via the first axis.

12. A magnetic-induction element as claimed in claim 11, further comprising a frame connected with the ring portion through the second axis.

13. A magnetic-induction element, comprising:
a substrate having a connecting structure; and
a magnetic-induction layer connected to the connecting structure and having an actuating portion and a first axis connected to the actuating portion.

14. A magnetic-induction element as claimed in claim 13, wherein the connecting structure comprises a first metal layer and a second metal layer.

15. A magnetic-induction element as claimed in claim 13, wherein the magnetic-induction layer is a third metal layer.

16. A magnetic-induction element as claimed in claim 15, wherein the third metal layer is one of a nickel layer and a nickel alloy layer.

17. A driving structure, comprising:
a frame comprising a first portion, a second portion and a third portion supporting a magnetic-induction element;
a first magnetic device mounted on the first portion;
a second magnetic device mounted on the second portion;
a generating device providing a variable magnetic field to the magnetic-induction element;
a mixer electrically connected to the generating device; and
a current source electrically connected to the mixer.

18. A driving structure as claimed in claim 17, wherein the first and second magnetic devices are permanent magnets having different magnetic poles.

19. A driving structure as claimed in 17, where the generating device causes an induction current generated on the magnetic-induction element.

20. A driving structure as claimed in claim 17, wherein the current source comprises a first current generating device and a second current generating device.

21. A driving structure, comprising:
a frame supporting a magnetic-induction element, a first magnetic device and a second magnetic device,
a generating device providing a variable magnetic field to the magnetic-induction element; and
a current source electrically connected to the generating device.

22. A driving structure as claimed in claim 21, wherein the first and second magnetic devices are permanent magnets having different magnetic poles.

23. A driving structure as claimed in 21, where the generating device causes an induction current generated on the magnetic-induction element.

24. A driving structure as claimed in claim 17, wherein the current source comprises a mixer, a first current generating device and a second current generating device.

25. A method for driving a magnetic-induction element, comprising steps of:
a) assembling a driving structure having a first magnetic device, a second magnetic device, and a supporting portion having the magnetic-induction element thereon, wherein a permanent magnetic field is provided between the first magnetic device and the second magnetic device;
b) providing a magnetic field to the magnetic-induction element; and
c) varying the magnetic field to form an induction current on the magnetic-induction element,
whereby the magnetic-induction element is driven by a Lorentz force generated between the induction current and the permanent magnetic field.

26. A method as claimed in claim 25, wherein the step c) is performed by controlling a current generating the magnetic field.

27. A method as claimed in claim 26, wherein the current is provided from a mixer.

28. A method as claimed in claim 26, wherein the current is provided from a mixer and a current generating device.

29. A method as claimed in claim 25, wherein the magnetic-induction element is one of a single-axis element and a dual-axis element.

30. A method for driving a magnetic-induction element, comprising steps of:
a) applying a first magnetic field to the magnetic-induction element;
b) providing a second magnetic field to be applied to the magnetic-induction element; and
c) varying the second magnetic field to form an induction current on the magnetic-induction element,
whereby the magnetic-induction element is driven by a Lorentz force generated between the induction current and the first magnetic field.

31. A method as claimed in claim 30, wherein the step c) is performed by controlling a current generating the magnetic field.

32. A method as claimed in claim 31, wherein the current is provided from a mixer and/or a current generating device.

33. A method as claimed in claim 30, wherein the magnetic-induction element is one of a single-axis element and a dual-axis element.

34. A method as claimed in claim 30, wherein the first magnetic field is a permanent magnetic field.

35. A projection system, comprising:
a driving structure comprising a first magnetic device, a second magnetic device and a generating device providing a magnetic field; and
a magnetic-induction element mounted between the first magnetic device and the second magnetic device and within the magnetic field.

36. A projection system as claimed in claim 35, wherein the first and second magnetic devices are permanent magnets having different magnetic poles.

37. A projection system as claimed in claim 36, wherein the magnetic-induction element is mounted within a permanent magnetic field formed by the first and second magnetic devices.

38. A projection system as claimed in 37, where the generating device causes an induction current generated on the magnetic-induction element.

39. A projection system as claimed in claim 38, wherein the magnetic-induction element is driven by a Lorentz force generated between the induction current and the permanent magnetic field.

40. A projection system as claimed in claim 35 further comprising a mixer.

41. A projection system as claimed in claim 35 further comprising a current source.

42. A projection system as claimed in claim 35, wherein the magnetic-induction element is one of a single-axis element and a dual-axis element.
